(19) United States
(12) Patent Application Publication
(10) Pub. No.: US 2008/0144059 A1
(43) Pub. Date: Jun. 19, 2008

(54) IMAGE PROCESSING APPARATUS AND METHOD THEREOF

(75) Inventor: Jun Nagai, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/954,566

(22) Filed: Dec. 12, 2007

(30) Foreign Application Priority Data
Dec. 14, 2006 (JP) 2006-337582

(51) Int. Cl. G06F 15/00

(52) U.S. Cl. 358/1.9

(57) ABSTRACT

A first shifted image is generated by shifting an image to be printed in a predetermined direction based on a first control value. A second shifted image is generated by shifting the image to be printed or the first shifted image in the predetermined direction based on a second control value. An image region to which the control of an amount of applied recording material is to be applied is extracted by making a logical operation of the image to be printed and the first and second shifted images.

### BACKGROUND OF THE INVENTION

1. Field of the Invention

The present invention relates to control of the amount of applied recording material.

2. Description of the Related Art

In an image processing apparatus of an electrophotography system such as a laser beam printer or the like, a charge roller uniformly charges a photosensitive drum. Then, a laser scanner emits a laser beam according to an image signal to expose the photosensitive drum by scanning, thereby forming an electrostatic latent image on the photosensitive drum. The electrostatic latent image is developed by a toner (recording material), the developed toner image is transferred onto a recording medium, and the toner is fixed on the recording medium by a fixing device, thereby printing an image.

When the amount of toner attached (i.e., applied) to a recording medium, i.e., a so-called amount of applied toner is large, the following problem is posed: the toner scatters because it is not completely fixed on the recording medium or because it falls off at places of high dot density. The frequency of occurrence of this problem varies depending on the humidity and temperature of the environment where a printer is set. Also, various types of recording media are used in printing, and the same problem may occur more frequently depending on the type of recording media.

When a line segment is printed in the main scanning direction of a recording medium, a problem often occurs wherein toner flies off backward and distorts an image. This problem is posed as follows: when a recording medium passes through a fixing device, vapor is produced by water in the recording medium, and is trapped by portions with large amounts of applied toner, thus blowing the toner off backward in the convey direction. This phenomenon is called “explosion”.

As a countermeasure against the aforementioned problems, a method of reducing the amount of applied toner is taken. More specifically, the developability is lowered; that is, the DC component of a developing bias is lowered, or dot thinning-out processing is applied to image data of an image to be printed, and so forth.

If the developability is lowered by weakening the developing bias, the amount of applied toner is reduced, thus effectively preventing fly-off and explosion of toner around a character image. However, this poses two problems: first, image quality is reduced because the amount of toner applied to the edge part of an image is radically reduced, and second a density stability drop occurring with long-term use of an image processing apparatus.

Moreover, after execution of the dot thinning-out processing, the problem of an image quality drop is noticeable. The image quality drop becomes conspicuous at low-density portions of an image. For example, assume that dot thinning-out processing is applied to 100% density image data 101 and 25% density image data 102 using 50% mask patterns 103 and 104. As a result of the dot thinning-out processing, the 100% density image data 101 becomes 50% density image data 105. However, the 25% density image data 102 may disappear, as denoted by reference numeral 106.

Japanese Patent Laid-Open Nos. 2000-175029 and 2001-080112 disclose a technique for applying thinning-out processing while preventing any image quality drop for the purpose of a reduction of the amount of applied toner. That is, an image pattern having a predetermined density and area is stored in advance, a region corresponding to the image pattern is extracted as a region to which image processing is to be applied, and the extracted region then undergoes the thinning-out processing.

The technique of Japanese Patent Laid-Open Nos. 2000-175029 and 2001-080112 requires registration of the image pattern used to apply the thinning-out processing, and this, in turn, requires a large storage capacity when a large number of image patterns are registered. An optimal amount of thinned-out dots varies depending on environmental variations and types of recording media. However, since the image pattern used to extract a region to which the thinning-out processing is to be applied is stored in a memory and is fixed, it is difficult to control the number of thinned-out dots. Furthermore, the extraction processing of a region to which the thinning-out processing is to be applied, and the dot thinning-out processing often require dedicated hardware in consideration of the processing speed, and cannot be easily implemented.

Moreover, the above technique uses pattern matching processing to extract a region to be applied the thinning-out processing. However, it is difficult to apply the pattern matching processing to a curved line part of an image or an image area having a complicated form. In other words, application of the thinning-out processing for the above portions of the image is very difficult.

### SUMMARY OF THE INVENTION

In one aspect, an image processing method comprising the steps of generating a first shifted image by shifting an image to be printed in a predetermined direction based on a first control value; generating a second shifted image by shifting the image to be printed or the first shifted image in the predetermined direction based on a second control value; and extracting an image region to which control of an amount of applied recording material is to be applied by making a logical operation of the image to be printed and the first and second shifted images.

According to this aspect, an image region where the amount of applied recording material is to be controlled can be appropriately extracted.

Further features of the present invention will become apparent from the following description of exemplary embodiments with reference to the attached drawings.

### BRIEF DESCRIPTION OF THE DRAWINGS

FIG. 1 is a view for explaining problems in the dot thinning-out processing;

FIG. 2 is a block diagram showing the arrangement of an image processing apparatus according to the first embodiment;

FIG. 3 is a block diagram showing the arrangement of a thinning-out information acquisition unit and thinning-out processor;

FIG. 4 shows examples of thinning-out patterns;

FIGS. 5A and 5B are views for explaining an extraction method of a region by a region extractor;

FIG. 6 shows the relationship between a thinning-out region width Δs and edge preservation width Δt, and that between application regions of normal processing and thinning-out processing;

FIGS. 7A and 7B are views for explaining logical operations between line buffers;

FIG. 8 is a flowchart for explaining processing for extracting the application region of the thinning-out processing;

FIG. 9A shows a UI provided by a thinning-out information acquisition unit according to the second embodiment;

FIG. 9B is a table showing the relationship among levels 1 to 6, the thinning-out region width Δs, and the edge preservation width Δt;

FIG. 10 is a block diagram showing the arrangement of an image processing apparatus according to the third embodiment;

FIG. 11 is a block diagram showing the arrangement of a thinning-out information acquisition unit and thinning-out processing controller;

FIG. 12 is a view for explaining generation of a thinning-out object by a thinning-out object generation unit;

FIG. 13 is a view showing the relationship between an original object and a thinning-out object; and

FIG. 14 shows a UI provided by a thinning-out processing information acquisition unit.

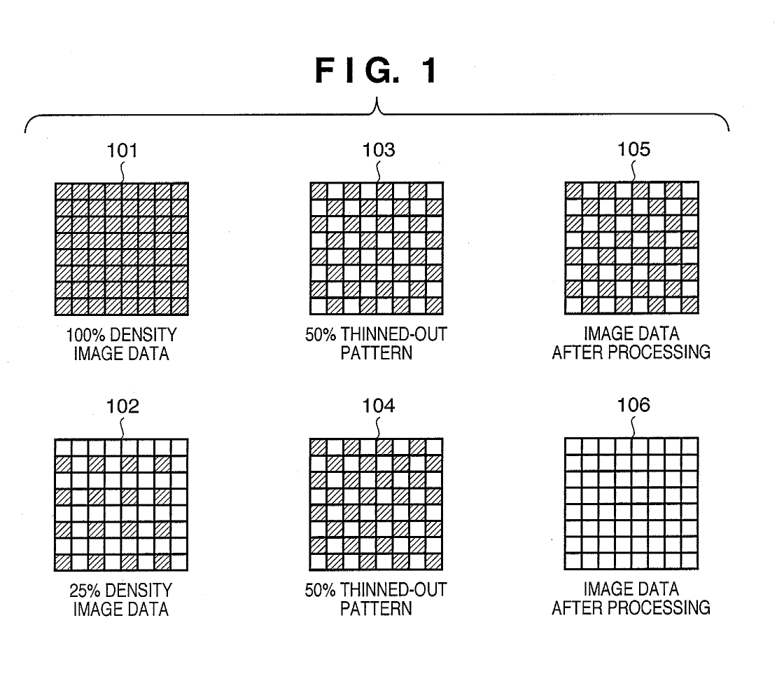

### DESCRIPTION OF THE EMBODIMENTS

Image processing according to the embodiments will be described in detail hereinafter with reference to the accompanying drawings.

### First Embodiment

### [Arrangement of Apparatus]

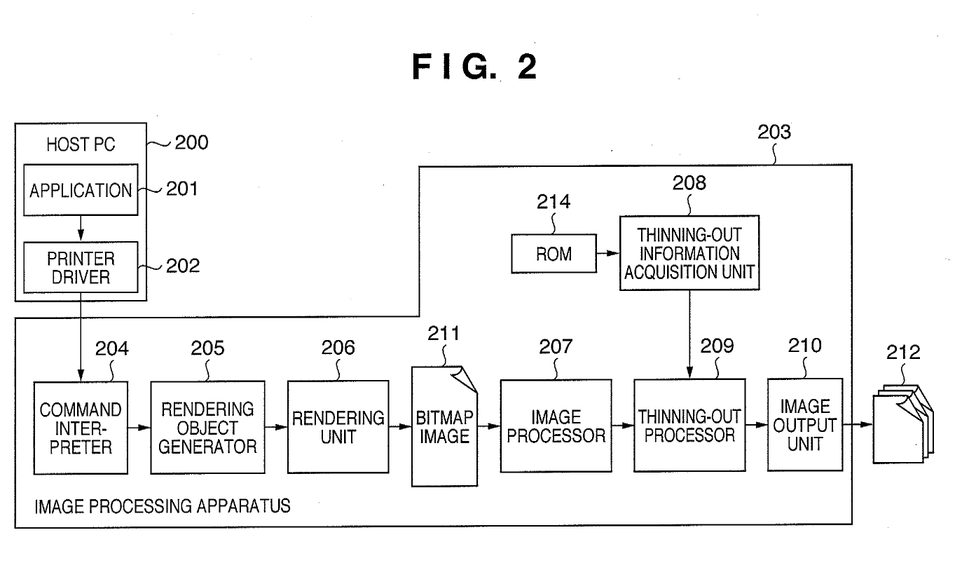

FIG. 2 is a block diagram showing the arrangement of an image processing apparatus 203 of the first embodiment.

An application 201 runs on a host computer (host PC) 200, and can be used to create digital documents such as a page layout document, word processor document, graphic document, and the like. A digital document created by the application 201 is sent to a printer driver 202, which generates rendering commands based on the digital document. The printer driver 202 normally generates rendering commands in a description language format such as a page description language (PDL) format or the like. The rendering commands include text, graphics, and image rendering instructions, and the like. The rendering commands generated by the printer driver 202 are transmitted to the image processing apparatus 203 via a network, serial bus, or the like.

The image processing apparatus 203 receives the rendering commands from the host PC 200, converts them into image data, and prints an image on a recording paper sheet. More specifically, a command interpreter 204 interprets the received rendering commands. A rendering object generator 205 generates rendering objects that a rendering unit 206 can process based on the data interpreted by the command interpreter 204. The rendering unit 206 renders the rendering objects to generate a bitmap image 211. An image processor 207 applies image processing such as color conversion processing, halftone processing, and the like to the bitmap image 211 to convert the bitmap image into an image format that an image output unit (printer engine) 210 can print.

When image data to be handled by the image output unit 210 is CMYK data corresponding to four colors, that is, C, M, Y, and K recording materials, and the bitmap image 211 is RGB format, the image processor 207 executes color conversion to convert RGB data into CMYK data. The number of tones that the image output unit 210 can print is normally a small number of tones such as two, four, 16 tones, or the like). Therefore, the image processor 207 applies halftone processing to allow an image output unit 210 with a small number of tones to attain stable halftone expression. Furthermore, the image processor 207 applies filter processing such as smoothing of the edges of character glyphs and the like, so as to obtain a more desirable image.

A thinning-out processor 209 applies dot thinning-out processing to image data output from the image processor 207 in accordance with control information of thinning-out processing input from a thinning-out information acquisition unit 208.

The image output unit 210 receives image data of a predetermined image format, and executes output processing for printing an image expressed by the image data on a recording paper sheet. Then, the image output unit 210 outputs a printout 212 obtained by printing an image corresponding to the rendering commands received from the host PC 200 on a recording paper sheet.

A read-only memory (ROM) 214 stores thinning-out patterns (to be described later) and the like.

[Thinning-Out Information Acquisition Unit and Thinning-Out Processor]

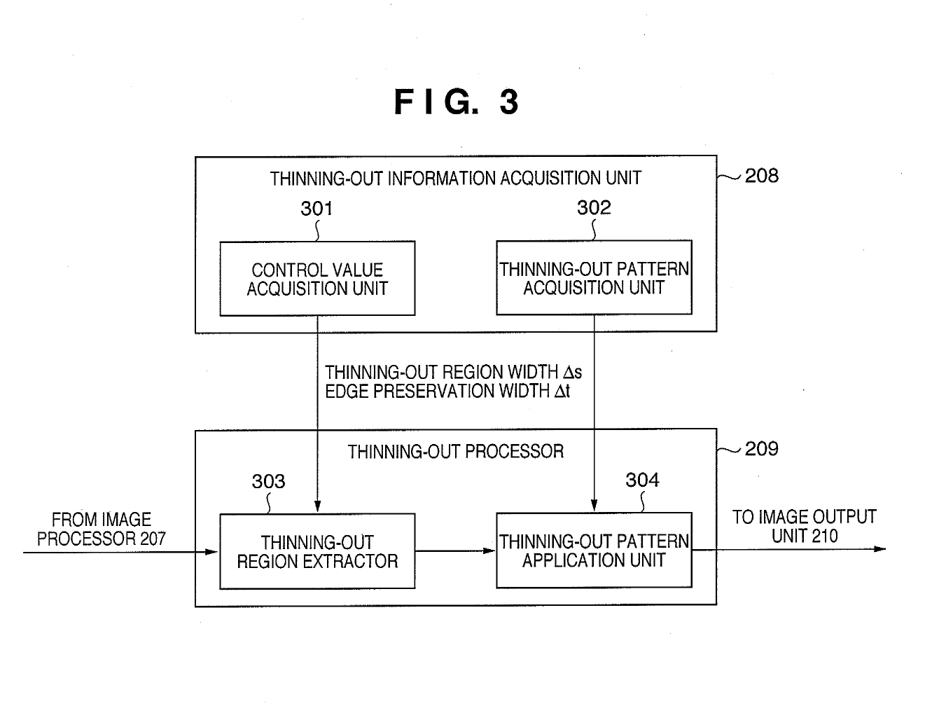

FIG. 3 is a block diagram showing the arrangement of the thinning-out information acquisition unit 208 and thinning-out processor 209.

A control value acquisition unit 301 acquires a thinning-out region width Δs and edge preservation width Δt, which are designated by an operator via, for example, an operation unit (not shown). Alternatively, the control value acquisition unit 301 may determine the thinning-out region width Δs and edge preservation width Δt based on signals from sensors and the like, which can acquire the state of the image processing apparatus.

A thinning-out pattern acquisition unit 302 acquires a thinning-out pattern stored in, for example, the ROM 214 in the image processing apparatus 203, or receives a thinning-out pattern from an external device via an input unit (not shown). If a plurality of thinning-out patterns are available, and must be selected, the thinning-out pattern acquisition unit 302 executes the following processing. That is, the thinning-out pattern acquisition unit 302 makes an operator select a thinning-out pattern using an operation unit (not shown) or selects an optimal thinning-out pattern based on a signal from a sensor which can acquire the environmental condition of the image processing apparatus 203.

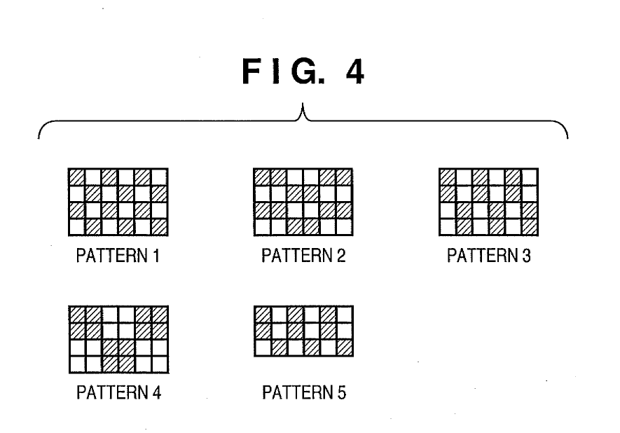

FIG. 4 shows examples of thinning-out patterns. FIG. 4 shows five types of thinning-out patterns. However, the thinning-out patterns are not limited to those shown in FIG. 4.

The thinning-out pattern is used when the thinning-out processor 209 executes thinning-out processing. More specifically, the thinning-out processing is implemented in such a manner that a thinning-out pattern application unit 304 makes logical operations of the thinning-out pattern and image data extracted by a thinning-out region extractor 303. The logical operation of the thinning-out pattern application unit 304 preserves image data corresponding to black dots of the thinning-out pattern, and deletes image data corresponding to white dots.

The thinning-out region extractor 303 extracts an application region of the thinning-out processing based on the thinning-out region width Δs (second control value) and edge preservation width Δt (first control value) acquired by the control value acquisition unit 301.

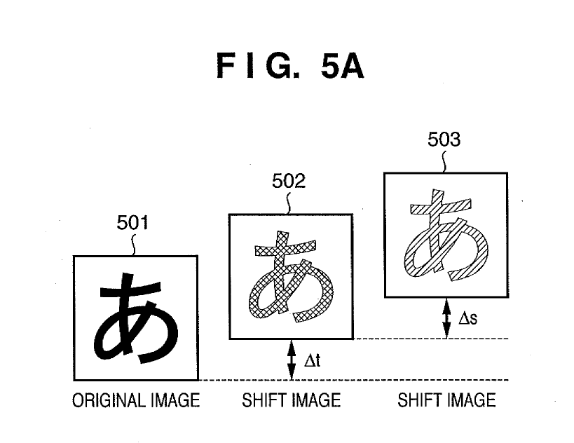

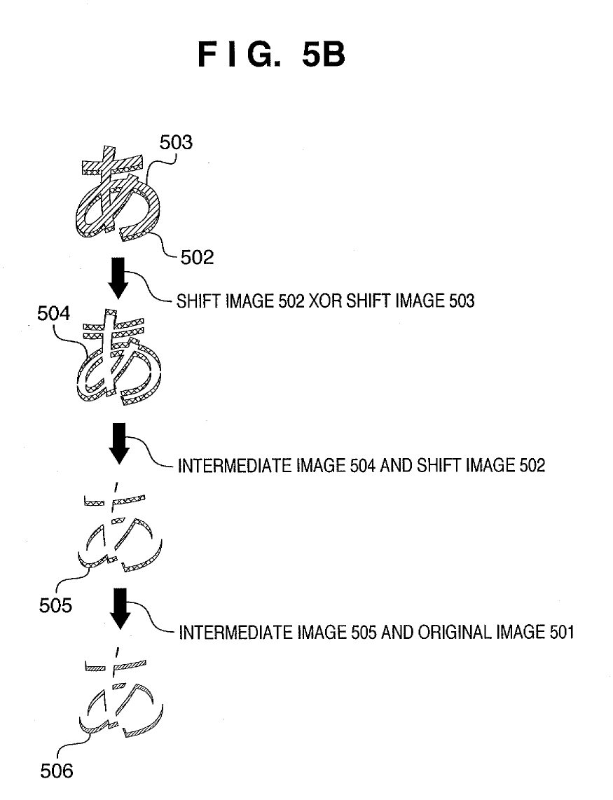

FIGS. 5A and 5B are views for explaining the region extraction method by the thinning-out region extractor 303.

The thinning-out region extractor 303 generates an image 502 by shifting image data (original image) 501 from which a region is to be extracted upward by pixels for the edge preservation width Δt. Furthermore, the thinning-out region extractor 303 generates an image 503 by shifting the image 502 upward by pixels for the thinning-out region width Δs. That is, the image 503 is shifted upward by Δs+Δt pixels from the original image 501.

Note that the shifted image 503 may be directly generated from the original image 501 by shifting the original image 501 by Δs+Δt pixels (third control value).

The thinning-out region extractor 303 XORs the shift images 502 and 503 to generate an intermediate image 504. The extractor 303 then ANDs the intermediate image 504 and the shift image 502 to generate an intermediate image 505. The thinning-out region extractor 303 ANDs the intermediate image 505 and original image 501 to extract an application region 506 of the thinning-out processing.

Note that the shift image is generated by shifting an image upward in the above example. However, the shift direction is not limited to the up direction. The up, down, right, and left directions may be selectively used as the shift direction for any purpose. Note that the application region 506 of the thinning-out processing effective for preventing explosion can be extracted by shifting an image upward.

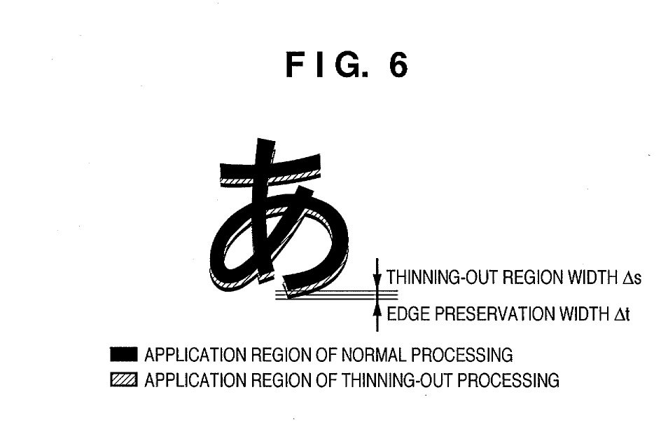

FIG. 6 shows the relationship between the thinning-out region width Δs and edge preservation width Δt, and that between the application regions of normal processing and thinning-out processing.

In FIG. 6, black solid portions correspond to the application region of normal print processing, and hatched portions correspond to that of the thinning-out processing. In this way, by making logical operations of an original image, and an image obtained by shifting the original image by the thinning-out region width Δs and edge preservation width Δt, the application region of the thinning-out processing can be easily extracted.

In the example of the extraction processing of the application region of the thinning-out processing, the shift processing is applied to all image data. However, since the thinning-out processing is executed after rendering, equivalent processing can be implemented by making logical operations of line buffers.

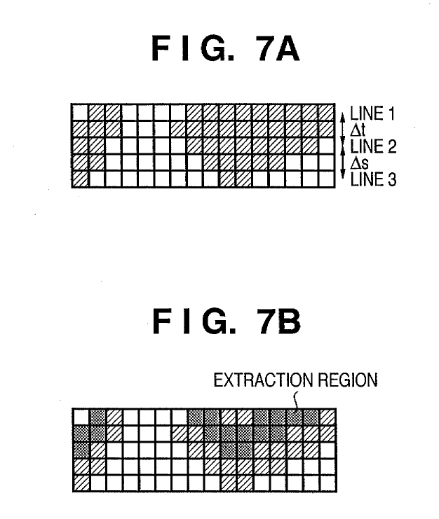

FIGS. 7A and 7B are views for explaining logical operations of line buffers. For example, the following description will be given under the assumption that the thinning-out region width Δs=2 and the edge preservation width Δt=2.

Upon extraction of the application region of the thinning-out processing in line 1, intermediate line 1 (not shown) is generated by XORing lines 2 and 3 in FIG. 7A. Next, intermediate line 2 (not shown) is generated by ANDing intermediate line 1 and line 2. Then, the application region of the thinning-out processing is extracted, as shown in FIG. 7B, by ANDing intermediate line 2 and line 1. The processing is done under the assumption that data outside the region of image data is data which is not printed.

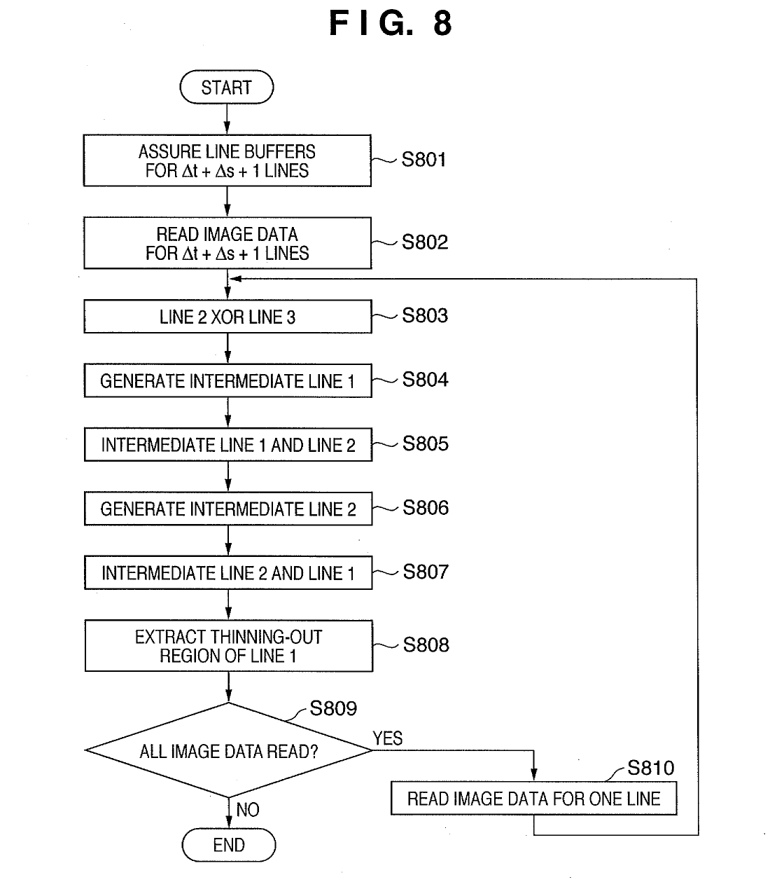

FIG. 8 is a flowchart for explaining the processing for extracting the application region of the thinning-out processing, which is executed by the thinning-out processor 209.

The thinning-out processor 209 assures line buffers for Δt+Δs+1 lines required for the processing based on the thinning-out region width Δs and edge preservation width Δt acquired by the control value acquisition unit 301 (S801). Next, the thinning-out processor 209 reads image data for Δs+Δt+1 lines (S802), and XORs lines 2 and 3 (S803), as described above with reference to FIG. 7A, thus generating intermediate line 1 (S804). The thinning-out processor 209 then ANDs intermediate lines 1 and 2 (S805) to generate intermediate line 2 (S806). The thinning-out processor 209 ANDs intermediate lines 2 and 1 (S807), thus extracting the application region of the thinning-out processing in association with line 1 (S808). The processor checks if all image data has been read (S809). If image data to be read still remains, the thinning-out processor 209 shifts the line buffers, and then reads image data for one line (S810). After that, the process returns to step S803. If no image data to be read remains, the extraction processing ends.

The thinning-out pattern application unit 304 makes logical operations of image data of the application region extracted in this manner using the thinning-out pattern acquired by the thinning-out pattern extraction unit 302, thereby implementing the thinning-out processing.

As described above, upon execution of the thinning-out processing, the application region of the thinning-out processing is appropriately extracted by making logical operations between images obtained by shifting an original image, and the thinning-out pattern can be selected as needed. Hence, the amount of applied recording material can be easily controlled to an optimal value while preserving the edge. Also, the control amounts associated with extraction of the application region of the thinning-out processing can be adjusted.

In addition, it is not necessary to register a large number of image patterns used in the thinning-out processing to a memory in advance, thus it becomes possible to reduce storage capacity of the memory.

As mentioned, application of the thinning-out processing for a curved line part of an image or an image area having a complicated form is very difficult when the pattern matching processing is used to extract a region to be applied the thinning-out processing. In contrast, images shifted from an original image are logical operated to extract a region to be applied the thinning-out processing in the embodiment. Accordingly, the thinning-out processing easily applies to the curved line part of the image and the image area having the complicated form in the embodiment.

### Second Embodiment

Image processing according to the second embodiment of the present invention will be described below. Note that the same reference numerals in the second embodiment denote the same components as those in the first embodiment, and a detailed description thereof will not be given.

In the description of the example of the first embodiment, the thinning-out region width Δs and edge preservation width Δt are set as the control values used to extract the application region of the thinning-out processing, and the control value acquisition unit 301 individually acquires these control values. However, these control values must be independently set, and the settings of these control values require knowledge about the image processing apparatus. Hence, the second embodiment will explain a method of easily setting the thinning-out region width Δs and edge presentation width Δt.

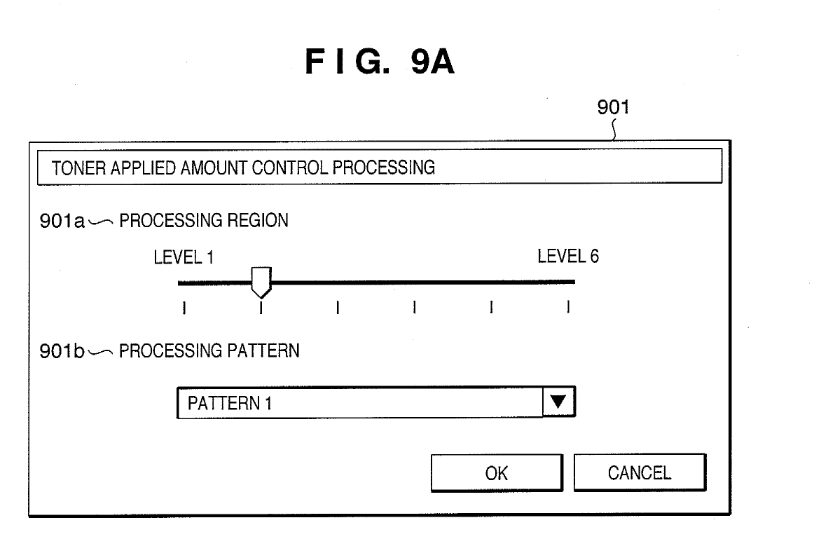

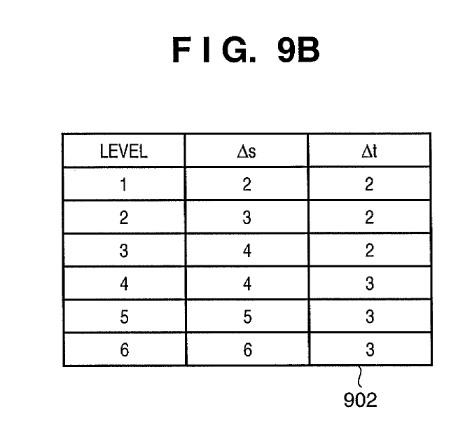

FIG. 9A shows a user interface (UI) provided by the thinning-out information acquisition unit 208 in the second embodiment. Note that this UI is displayed on an operation unit (not shown) or the like.

On a UI 901, an area denoted by reference numeral 901a corresponds to a UI of the control value acquisition unit 301. In the first embodiment, the user must set values (the numbers of pixels) for the thinning-out region width Δs and edge preservation width Δt, respectively. However, in the second embodiment, the user sets these widths using relative values from levels 1 to 6.

FIG. 9B shows the relationship between levels 1 to 6, the thinning-out region width Δs, and the edge preservation width Δt. That is, the second embodiment presets Δs and Δt for respective level values, and prompts the user to select these control values regardless of practical values, thus easily designating the application region of the thinning-out processing. Note that the preset values are stored in advance in a memory such as the ROM 214 or the like, but they consume the memory capacity much less than that of image patterns used in pattern matching.

On the UI 901, an area denoted by reference numeral 901b corresponds to a UI of the thinning-out pattern acquisition unit 302, and allows the user to select an arbitrary thinning-out pattern from a drop-down menu.

As described above, the control values and thinning-out patterns for the thinning-out processing are prepared in a memory such as the ROM 214 or the like, and the user can select the control values and thinning-out pattern using the UI. Therefore, the control amounts can be selected more easily, and the amount of applied recording material can be appropriately controlled.

### Third Embodiment

Image processing according to the third embodiment of the present invention will be described below. Note that the same reference numerals in the third embodiment denote the same components as those in the first and second embodiments, and a detailed description thereof will not be given.

In the first embodiment, original image data used upon extracting the application region of the thinning-out processing is the bitmap image 211 after rendering, and the method of extracting the application region of the thinning-out processing by making logical operations of the bitmap image 211 has been explained. However, upon controlling the amount of applied toner, only limited control such as a change of the application region of the thinning-out processing, that of the thinning-out pattern, and the like can only be applied to pixel information of the bitmap image 211. The third embodiment will explain more flexible applied amount control. More specifically, after or at the time of generation of a rendering object, the application region of the thinning-out processing is created as a new object, and the amount of applied toner is controlled for that object.

[Arrangement of Apparatus]

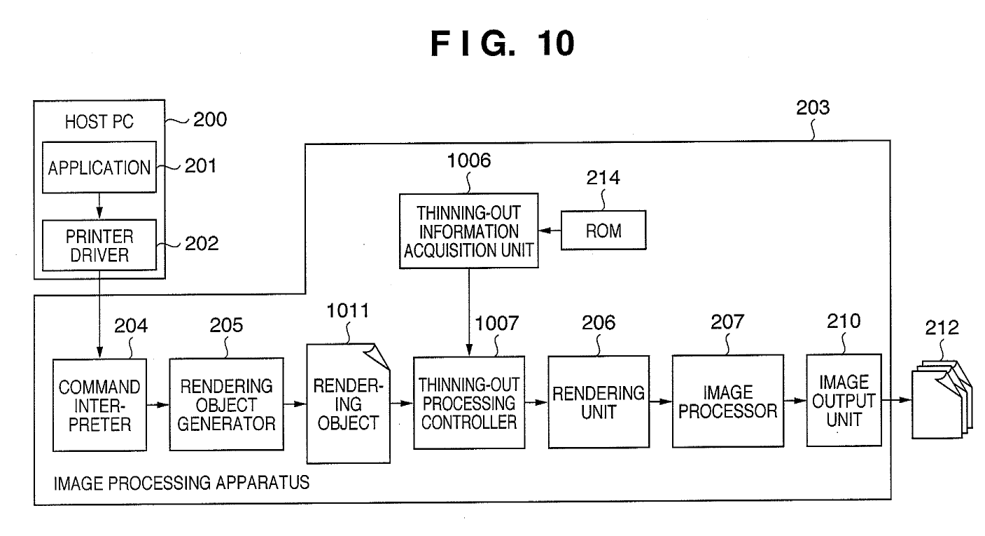

FIG. 10 is a block diagram showing the arrangement of an image processing apparatus 203 according to the third embodiment.

A thinning-out processing controller 1007 creates an object (to be referred to as “thinning-out object” hereinafter) according to control information of the thinning-out processing input from a thinning-out information acquisition unit 1006, and adds and sets it to rendering objects 1011 output from the rendering object generator 205.

The rendering unit 206 renders the rendering objects 1011 which are generated by the rendering object generator 205 and to which the thinning-out object is added and set by the thinning-out processing controller 1007, thereby generating a bitmap image.

[Thinning-Out Information Acquisition Unit and Thinning-Out Processor]

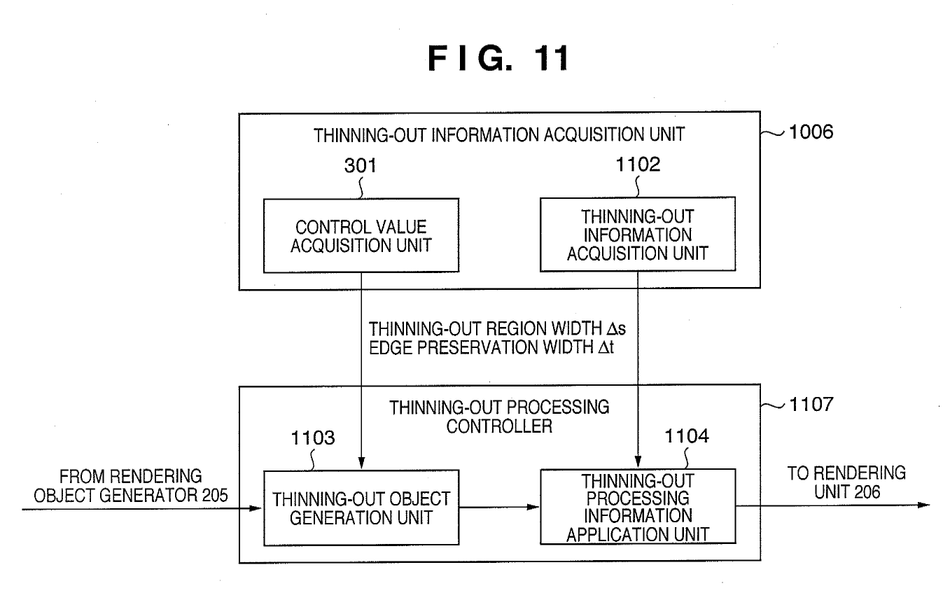

FIG. 11 is a block diagram showing the arrangement of the thinning-out information acquisition unit 1006 and thinning-out processing controller 1007.

A thinning-object generation unit 1103 generates a thinning-out object for the rendering objects 1011 using the thinning-out region width Δs and edge preservation width Δt acquired by the control value acquisition unit 301. The thinning-out object generation algorithm is the same as that explained using FIG. 5 in the first embodiment. The thinning-out region extractor 303 of the first embodiment applies the shift processing and logical operation processing to the bitmap image 211. By contrast, the thinning-object generation unit 1103 applies the shift processing to the rendering objects 1011, and executes logical operation processing of objects to generate a new thinning-out object.

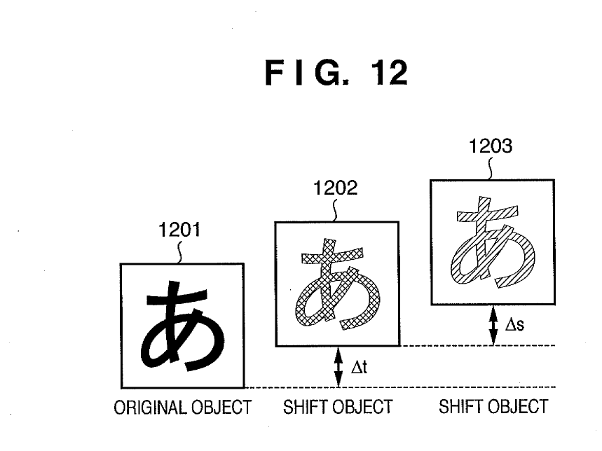

FIG. 12 is a view for explaining generation of a thinning-out object by the thinning-object generation unit 1103.

The thinning-object generation unit 1103 generates an object 1202 by shifting upward an object (original object) 1201 for which a thinning-out object is to be generated by pixels for the edge preservation width Δt. Furthermore, the thinning-object generation unit 1103 generates an object 1203 by shifting the object 1202 by pixels for the thinning-out region width Δs upward. That is, the object 1203 is shifted upward by Δs+Δt pixels from the original object 1201.

As in the first embodiment, the thinning-object generation unit 1103 generates intermediate object 1 by XORing the shift objects 1202 and 1203. The thinning-object generation unit 1103 then generates intermediate object 2 by ANDing intermediate object 1 and the shift object 1202. The thinning-object generation unit 1103 generates a thinning-out object by ANDing intermediate object 2 and the original object 1201.

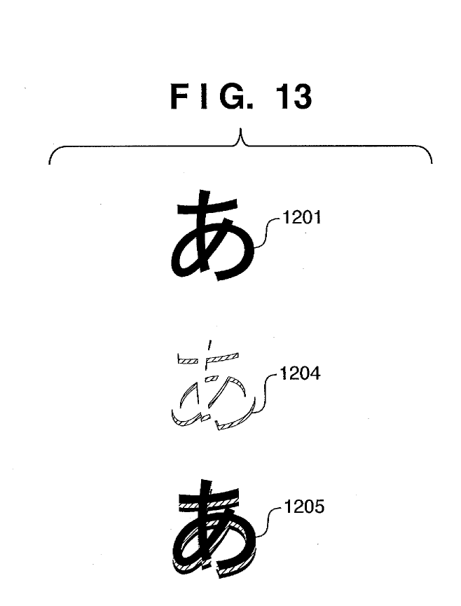

FIG. 13 shows the relationship between the original object 1201 and thinning-out object 1204. From these two objects 1201 and 1204, a bitmap image 1205 is rendered.

Normally, the original object 1201 generated by the rendering object generator 205 has density level information and information about halftone processing to be applied by the image processor 207 in addition to its position information and shape information. On the other hand, the thinning-out object 1204 normally has the same information as the original object 1201 except for its position information and shape information. In the third embodiment, a thinning-out processing information acquisition unit 1102 shown in FIG. 11 acquires density level information and information about the halftone processing, which are associated with the thinning out object 1204. A thinning-out information application unit 1104 applies the acquired density level information and information about the halftone processing to the thinning-out object 1204.

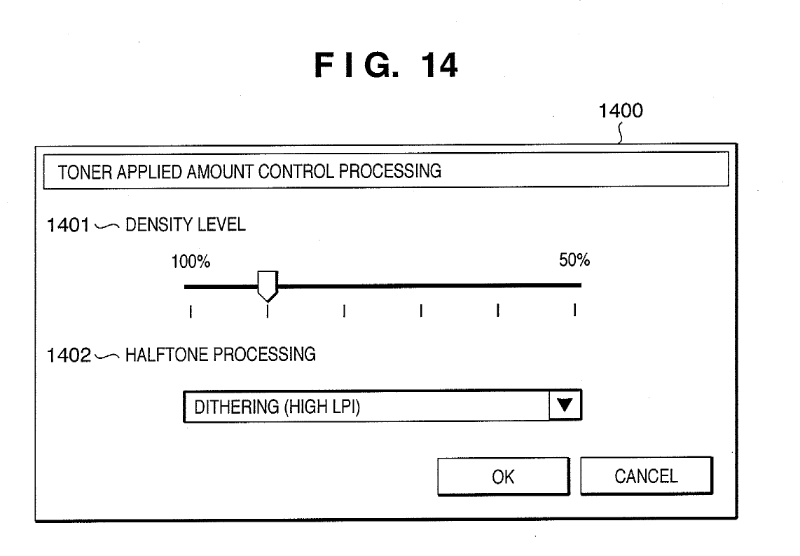

FIG. 14 shows a UI provided by the thinning-out processing information acquisition unit 1102. Note that this UI is displayed on an operation unit (not shown) or the like.

On a UI 1400, an area denoted by reference numeral 1401 is used to set density information associated with the thinning-out object 1204. When the user sets 100% using a slider of this area, a density value same as that of the original object 1201 is set; when he or she sets 50%, a density value half that of the original object 1201 is set. In other words, the user sets density information to reduce the amount of applied recording material of an image region corresponding to the thinning-out object 1204.

An area denoted by reference numeral 1402 is used to set a halftone processing method associated with the thinning-out object 1204. The operator can set halftone processing of the image processor 207 to be applied to a bitmap image corresponding to the thinning-out object 1204 after rendering. FIG. 14 shows an application example of dithering (high LPI). Also, various other kinds of halftone processing such as dithering with a different LPI value (low LPI or the like), error diffusion, and the like can be selected.

In this manner, s thinning-out object is generated by applying the shift processing and the AND processing to the rendering objects before rendering, and the density and image processing method associated with the thinning-out objects are selected as needed. Therefore, the amount of applied recording material can be optimally controlled more easily while preserving the edge.

### Exemplary Embodiments

The present invention can be applied to a system constituted by a plurality of devices (e.g., host computer, interface, reader, printer) or to an apparatus comprising a single device (e.g., copying machine, facsimile machine).

Further, the present invention can provide a storage medium storing program code for performing the above-described processes to a computer system or apparatus (e.g., a personal computer), reading the program code, by a CPU or MPU of the computer system or apparatus, from the storage medium, then executing the program.

In this case, the program code read from the storage medium realizes the functions according to the embodiments.

Further, the storage medium, such as a floppy disk, a hard disk, an optical disk, a magneto-optical disk, CD-ROM, CD-R, a magnetic tape, a non-volatile type memory card, and ROM can be used for providing the program code.

Furthermore, besides above-described functions according to the above embodiments can be realized by executing the program code that is read by a computer, the present invention includes a case where an OS (operating system) or the like working on the computer performs a part or entire processes in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part. or entire process in accordance with designations of the program code and realizes functions of the above embodiments.

In a case where the present invention is applied to the aforesaid storage medium, the storage medium stores program code corresponding to the flowcharts described in the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-337582, filed Dec. 14, 2006, which is hereby incorporated by reference herein in its entirety.

What is claimed is:

1. An image processing apparatus comprising:
a first shifter, arranged to generate a first shifted image by shifting an image to be printed in a predetermined direction based on a first control value;
a second shifter, arranged to generate a second shifted image by shifting the image to be printed or the first shifted image in the predetermined direction based on a second control value; and
an extractor, arranged to extract an image region to which control of an amount of applied recording material is to be applied by making a logical operation of the image to be printed and the first and second shifted images.

2. The apparatus according to claim 1, further comprising a generator arranged to generate image data of a rendering object format by interpreting image data of the image to be printed, wherein the first and second shifted images are expressed by the image data of the rendering object format.

3. The apparatus according to claim 1, further comprising a rendering section arranged to render image data of the image to be printed, wherein the first and second shifted images are expressed by image data of a bitmap format.

4. The apparatus according to claim 1, further comprising an input section arranged to input the first and second control values.

5. The apparatus according to claim 1, further comprising:
a memory which stores combinations of the first and second control values; and
a selector, arranged to manually select one of the combinations.

6. The apparatus according to claim 1, further comprising a processor arranged to apply image processing for controlling the amount of applied recording material to the extracted image region.

7. The apparatus according to claim 6, wherein said processor reduces a density value of pixels of the extracted image region as the control of the amount of applied recording material.

8. The apparatus according to claim 6, wherein said processor thins out dots of the extracted image region as the control of the amount of applied recording material.

9. The apparatus according to claim 1, wherein said extractor generates a first intermediate image by computing an exclusive logical sum of the first and second shifted images, generates a second intermediate image by computing a logical product of the first intermediate image and first shifted image, and extracts the image region to which the control of the amount of applied recording material is applied by computing a logical product of the second intermediate image and the image to be printed.

10. An image processing method comprising the steps of:
generating a first shifted image by shifting an image to be printed in a predetermined direction based on a first control value;
generating a second shifted image by shifting the image to be printed or the first shifted image in the predetermined direction based on a second control value; and
extracting an image region to which control of an amount of applied recording material is to be applied by making a logical operation of the image to be printed and the first and second shifted images.

11. A computer-readable storage medium storing a computer executable program for causing a computer to implement an image processing apparatus according to claim 1.
